(19) United States
(12) Patent Application Publication
(10) Pub. No.: US 2011/0217687 A1
(43) Pub. Date: Sep. 8, 2011

(54) EXAMINATION SYSTEM AND METHOD THEREOF

(75) Inventors: CHIA-CHUN YEH, Hsinchu City (TW); HENRY WANG, Hsinchu City (TW); YAO PENG, Hsinchu City (TW); TZU-MING WANG, Hsinchu City (TW)

(73) Assignee: E INK HOLDINGS INC., Hsinchu City (TW)

(21) Appl. No.: 12/834,318

(22) Filed: Jul. 12, 2010

(30) Foreign Application Priority Data
Mar. 8, 2010 (TW) 99106594

(51) Int. Cl. G09B 7/00

(52) U.S. Cl. 434/362

(57) ABSTRACT

An examination system and an examination method are disclosed. The examination method includes: generating a first test data by a host device, in which the first test data has a plurality of questions; rearranging the questions of the first test data in order to generate a second test data; and sending the second test data to a corresponding examination device for taking the examination. An anti-cheating module is provided for detecting distances between the examination devices or detecting a deviation angle of a character image of the examinee. When the distance is less than a predetermined value or the deviation angle is greater than a predetermined value, an anti-cheating signal is then generated for avoiding cheating actions.

### BACKGROUND OF THE INVENTION

1. Field of the Invention

The present invention relates to an examination system of education, especially relating to an examination system and method thereof with cheating-minimization capability.

2. Description of Related Art

Generally, conventional education method involves a teacher teaching several students according to some written-form teaching materials. The conventional method for evaluating the individual achievements of learning is taking examinations using examination papers.

Conventional education and evaluation methods usually consume significant human resources, time, and other supporting resources. Conventional education methods require many teachers for teaching many areas of knowledge, and needs many textbooks. With the increasing number of courses, the number of books being brought by the students increases, thus adding extra burdens for the student. Moreover, conventional method for evaluating the achievements or accomplishments of learning needs to gather the examinees, print a large number of examination papers, provide significant proctor effort, or notable invigilation, examination grading resources, and print considerable quantities of report cards.

Electronic book devices have some advantages including capabilities of repeatable reading, display variety, huge data storing capability and quantity, ease of carrying, and archiving papers. Thus, using such devices for reading and learning can reduce the burdens of the student and enhance or increase the efficiency of learning. Additionally, electronic book devices are able to connect to the Internet for data searching, thereby so as to broadening the scope of accessible resources and learning.

However, while the learning method is improved, the traditional method of evaluating achievement of learning still remains as the conventional paper examination. The conventional paper examination may encourage some cheating, such as writing relevant information on the table, peeking at the answers of other examinees, or handing around a slip of paper, etc. This may cause some negative influence to the fairness of the examination, and cause incorrect or improper evaluation result.

Therefore, a method for avoiding cheating must be carried out while taking examinations through the electronic book devices, to increase the sanctity of the evaluation result.

### SUMMARY OF THE INVENTION

One of the purposes of the present invention is to provide an anti-cheating examination system, to prevent examinee cheating during an examination in any manner.

Another purpose of the present invention is to provide a fair examination system by rearranging the questions of the test data by a randomizing module, so as to display the test data with different question order at different examination devices.

Still another purpose of the present invention is to provide a fair examination system by detecting the distance between the examination devices, so as to avoid examination cheating.

Still another purpose of the present invention is to provide a fair examination system by preventing the examinees from deviating the corresponding examination device (because this may represent that the examinees are going to peek others' answers).

According to the present invention, an examination system is disclosed. The system includes a host device which has a database for storing a plurality of questions and answers, in which the answers are respectively associated with the questions; a randomizing module having a rearrangement function; a first communication module for data sending and receiving; a first verification module for generating a verification signal according to a set of verification data; and a processing unit coupling with the database, the randomizing module, the first communication module, and the first verification module, for generating a first test data from the database according to the verification signal. The first test data has some of the questions which are stored in the database. The first processing unit controls the randomizing module for rearranging the questions of the first test data in order to generate a second test data, though still maintaining the association between the rearranged questions and answers. The second test data is transmitted by the first communication module.

The examination system further includes an examination device which has an input unit for receiving an input signal; a second communication module for sending and receiving data; a display unit for displaying the second test data; a second verification module for generating the verification data; an anti-cheating module for generating an anti-cheating signal; a storage unit for storing the input signal and the second test data; and a second processing unit coupling with the second communication module, the input unit, the display unit, the second verification module, the anti-cheating module, and the storage unit. The second processing unit controls the second communication module for sending the verification data to the host device, receives the second test data for displaying at the display unit, send the input signal to the host device, and generate an anti-cheating action according to the anti-cheating signal.

According to the present invention, an examination method is disclosed. The method includes: generating a first test data by a host device, in which the first test data has a plurality of questions; rearranging the questions of the first test data for generating a second test data; and sending the second test data to a corresponding examination device.

According to the present invention, an examination method is disclosed. The method includes: generating a test data by a host device and sending the test data to an examination device; displaying the test data by the examination device, and generating an anti-cheating signal by an anti-cheating module; and generating a reply data by the examination device, and sending the reply data to the host device for generating an examination score.

Wherein the step of generating the anti-cheating signal may further include: detecting a distance between the examination device and other examination device. When the distance is less than a predetermined value, the anti-cheating signal is then generated.

Additionally, the step of generating the anti-cheating signal may further include: detecting a character image. When a deviation angle of the character image is greater than a predetermined value, the anti-cheating signal is then generated.

For further understanding of the invention, reference is made to the following detailed description illustrating the embodiments and examples of the invention. The description is only for illustrating the invention, not for limiting the scope of the claim.

### BRIEF DESCRIPTION OF THE DRAWINGS

The drawings included herein provide further understanding of the invention. A brief introduction of the drawings is as follows:

FIG. 1 is a system diagram of the examination system with cheating-minimization capability according to one embodiment of the present invention; and

FIG. 2 is a flow chart of examination method of the examination system with cheating-minimization capability according to one embodiment of the present invention.

### DETAILED DESCRIPTION OF THE PREFERRED EMBODIMENTS

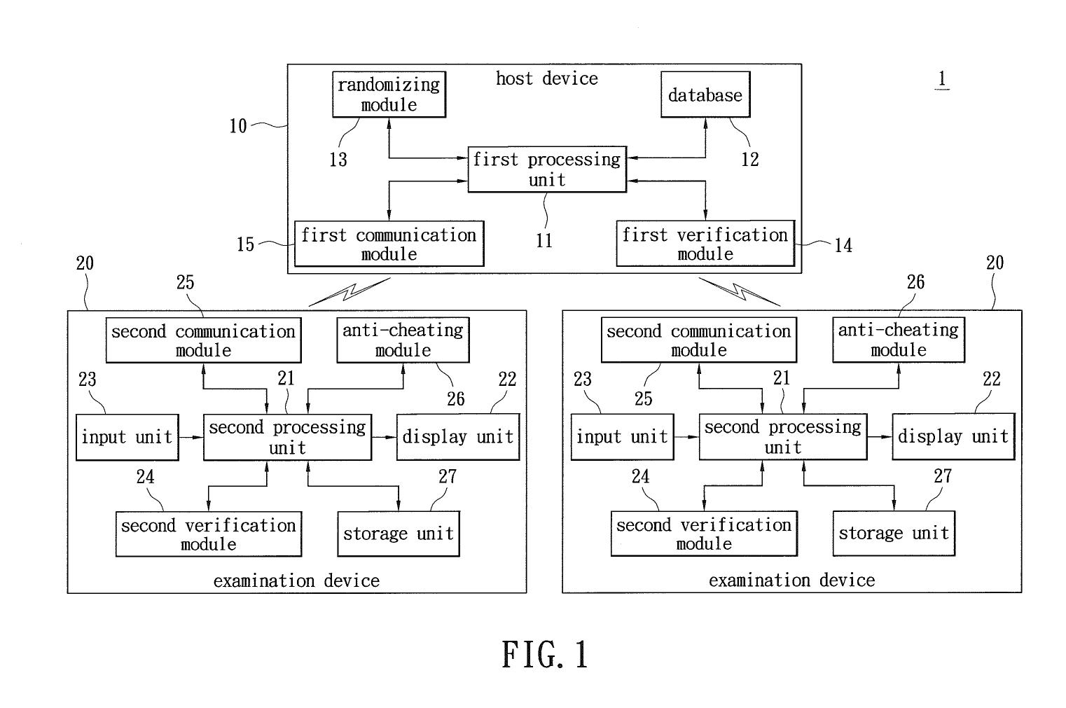

FIG. 1 is a system diagram of the examination system with cheating-minimization capability according to one embodiment of the present invention.

The examination system includes a host device 10 and a plurality of examination devices 20. Wherein the host device 10 may be a computer host, and may be set at the education certification institutions such as a school, a cram school, an examination center, etc. The examination device 20 may be an electronic book device, a notebook computer, a desktop computer, or a PDA, and may be set at a class room or an examination taking center, etc.

The host device 10 has a first processing unit 11 which is connected with a database 12, a randomizing module 13, a first verification module 14, and a first communication module 15. In which the database 12 stores a plurality of questions and the corresponding answers, for generating a first test data by the first processing unit 11. The randomizing module is capable of randomly rearranging the questions in the first test data, or rearranging the questions of the first test data according to a function for generating a second test data. The first verification module 14 is for verifying the identity of the examinee and the examination device 20 and generating a verification signal according to an identity verification key, a machine code serial number and a program code serial number of the examination device 20.

The first processing unit 11 generates the first test data according to the verification signal. And the verification signal is used as a parameter of the function of the randomizing module 13 for generating the second test data with different question orders corresponding to different examinees and different examination devices 20. The first communication module 15 may communicate wirelessly or wiredly with the second communication modules 25 of the examination devices 20. Additionally, the communication module 15 may send the examination score of the examinees through the Internet, E-mail, or short message of mobile phone.

The examination device 20 has a second processing unit 21 which connects with a display unit 22, an input unit 23, a second verification module 24, a second communication module 25, an anti-cheating module 26, and a storage unit 27. Wherein the display unit 22 is controlled by the second processing unit 21 for displaying the second test data. The input unit 23 may let the examinee inputs an input signal. In which the input signal includes a replay data and the identity verification key, etc. The second verification module 24 is for generating the verification data, and sending the verification data to the host device 10 for confirming the identity of the examinee and the examination device 20. The second communication module 25 may send and receive data with the first communication module 15 of the host device 10, such as receiving the second test data and the examination score, and sending the reply data and the verification data, etc. The anti-cheating module 26 is for providing a cheating-minimization capability. The storage unit 27 may stores the second test data received by the second communication module 25, the reply data inputted by the examinee, the program code serial number, and an anti-cheating record generated by the anti-cheating module 26.

When the examination system 1 starts the examination, the examinee may input the identity verification key. The verification data may be sent to the first verification module 14 of the host device 10 through the second communication module 25 by the second verification module 24. In which the identity verification key is for verifying the identity of the examinee and the corresponding examination device 20.

After the identity verification, the host device 10 generates the first test data from the database 12. The randomizing module 13 may then rearranging the questions of the first test data for generating the second test data, corresponding to different identity verification key, machine code serial number and program code serial number of the examination device 20. After that, the second test data is sent to the corresponding examination device 20 through the first communication module 15. By doing so, different examinee and examination device 20 may receive the second test data in different question order.

The examination device 20 receives the second test data through the second communication module 25. The second test data would then be displayed on the display unit 22, and the second processing unit 21 would count time right after the second test data is displayed. The examinee may reply to the questions and input the reply data. The second processing unit 21 receives the reply data, displays the reply data through the display unit 22, and stores the reply data into the storage unit 27.

When the examinee finishes the questions or the counted time reaches the maximum completion time of the examination, the second processing unit 21 would then send the reply data to the host device 10 through the second communication module 25. The host device 10 compares the replay data with the correct answers corresponding to the second test data, and generates the examination score which may result from a score points or leveling function. The examination score would be sent to corresponding examination device 20 and be displayed at the display unit 22. Thus, the examinee can receive the score and answer of the taken examination. Wherein the host device 10 may restore the question order of each reply data according to the verification data correspondingly, for comparing the replies and the answers.

Additionally, the host device 10 may send the examination score to the predetermined E-mail addresses through the Internet by the first communication module 15. Alternatively, the examination score may also be sent in a short message to a mobile phone.

As described above, the randomizing module 13 of the host device 10 may rearrange the question order of the first test data according to a function or by random, for generating the second test data which have different question orders. Furthermore, each second test data may have different question order corresponding to different examination devices 20. Therefore, the examinees may not cheat on the examination by referring to the replies of other nearby examinees, or by sending slips of paper around.

Moreover, the examination device 20 may further include an anti-cheating module 26. The anti-cheating module 26 may be a distance detection unit, for detecting the distances between the corresponding examination device 20 and other examination devices 20. In which, the distance detection unit may be an infrared distance detection unit or a radio distance detection unit. Specifically, the minimum distance between two examination devices 20 may be set to a predetermined value. Thus, by detecting the distance between the corresponding examination device 20 and other examination devices 20, the situation that the examinee moves the examination device 20 too close to others may be avoided, in order to avoid examination cheating.

If the examination device 20 detects the distance with other examination device 20 is close to a predetermined value, then the anti-cheating module 26 may generate a warning signal for warning the examinee. And if the distance is less than the predetermined value, the anti-cheating module 26 may generate an anti-cheating signal. The second processing unit 21 of the examination device 20 would generate an anti-cheating action which may include: closing the display unit 22; closing the input unit 23; generating an anti-cheating record and string the anti-cheating record in the storage unit 27; or generate a signal for terminating the examination and sending a notice to the host device 10 for stopping the examination. Therefore, the examinees may be kept far from each other and cheating actions may be avoided.

According to another embodiment of the present invention, the anti-cheating module 26 of the examination device 20 may be an image system which may be accomplished by a CCD or CMOS image module. The image system can be installed at any location of the examination device 20. When the examinee is taking examination, the deviation angle of the character image of the examinee should within a predetermined value. If the deviation angle of the examinee is large than the predetermined value, it may represent that the examinee is too far from the corresponding examination device 20 or the examinee is referring the replies of other nearby examinees.

By detecting the deviation angle of the character image, the position of the corresponding examinee may be determined. If the deviation angle of the character image almost reaches the predetermined value, the examination device 20 may generate a signal for warning the corresponding examinee. And if the deviation angle of the character image is greater than the predetermined value, the anti-cheating module 26 generates an anti-cheating signal. The second processing unit 21 of the examination device 20 then generates an anti-cheating action according to the anti-cheating signal. The anti-cheating action may include: closing the display unit 22 and the input unit 23; generating an anti-cheating record and storing the anti-cheating record in the storage unit 27; or generating a signal for terminating the examination and sending a notice to the host device 10 through the second communication unit 25.

The anti-cheating module 26 may generate the warning signal when any unusual situation is detected, and generate the anti-cheating signal when the predetermined situation is met. The warning signal and the anti-cheating signal generated by the anti-cheating module 26 may be stored at the storage unit 27 in order to form the anti-cheating record. And the anti-cheating record may serve as a reference when generating the examination score. The fairness may be improved by doing the aforementioned methods of the embodiments of the present invention.

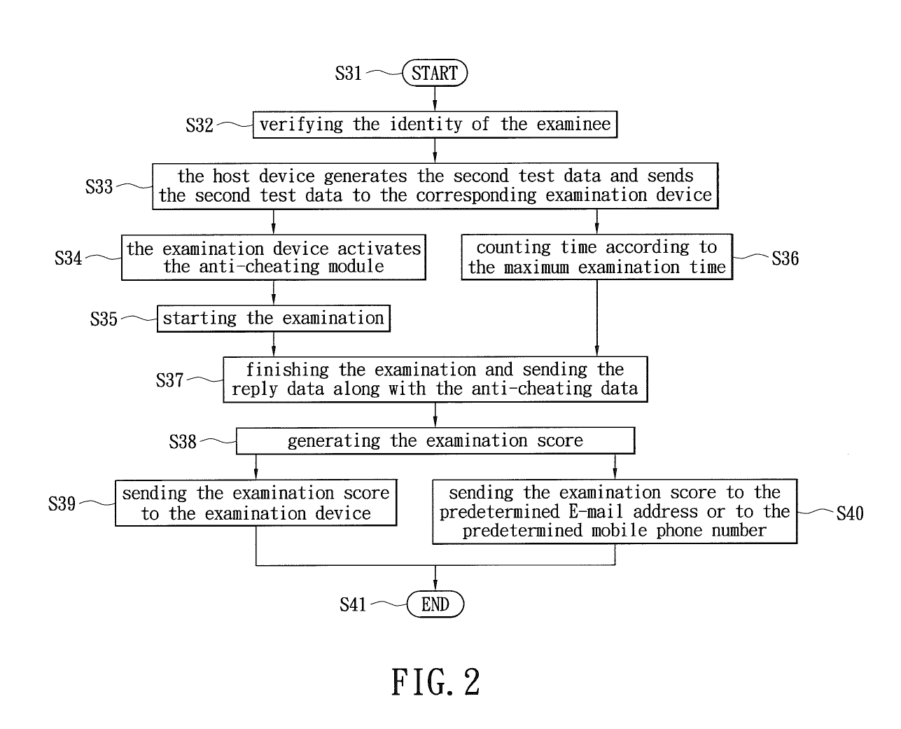

Please refer to FIG. 2, which is a flow chart executed by the examination system with cheating-minimization capability according to one embodiment of the present invention.

The examinee may start the examination by using the examination device 20 (S31). The examination device 20 would sent the identity verification key of the examinee, the machine code serial number and the program code serial number of the examination device 20 to the host device 10 through the second communication module 25 for verifying the identity of the examinee (S32). When the host device verifies the identity of the examinee, the first test data is then generated from the database 12 by the first processing unit 11. By the randomizing module 13, the questions of the first test data are then rearranged for generating the second test data, and the second test data is sent to the corresponding examination device 20 (S33).

After that, the anti-cheating module 26 of the examination device 20 is activated for controlling the distance between each examination device 20 or monitoring the deviation angle of the character image of the examinee (S34). Simultaneously, the second processing unit 21 counts the time according to the maximum examination time of the second test data (S36). The examinee can take the examination at the same time (S35).

During the examination is taken, if the examinee moves the examination device 20 toward another examination device 20, the anti-cheating module 26 would detect that the distance between the two examination devices 20 is close to the predetermined value, and the warning signal is then generated for warning the examinees. If the distance is less than the predetermined value, the anti-cheating module 26 would generate the anti-cheating signal. The second processing unit 21 of the examination device 20 then generates the anti-cheating action according to the anti-cheating signal. The anti-cheating action may include: closing the display unit 22; closing the input unit 23; generating an anti-cheating record and string the anti-cheating record in the storage unit 27; or generate a signal for terminating the examination and sending a notice to the host device 10 for finishing the examination.

During the examination is taken, if the deviation angle of the character image of the examinee is close to the predetermined value, the anti-cheating module 26 may generate the warning signal for warning the examinee. And if the deviation angle of the character image of the examinee is greater than the predetermined value, the anti-cheating module 26 may generate the anti-cheating signal. The second processing unit 21 of the examination device 20 then generates the anti-cheating action according to the anti-cheating signal. The anti-cheating action may include: closing the display unit 22; closing the input unit 23; generating an anti-cheating record and string the anti-cheating record in the storage unit 27; or generate a signal for terminating the examination and sending a notice to the host device 10 for finishing the examination.

The examinee may press “examination completed” when the second test data is finished, and then the second processing unit 21 would generate an examination-finished signal. After that, the examination device 20 sends the examination-finished signal, the reply data, the anti-cheating record, and the verification data to the host device 10 through the second communication module 25 (S37).

The host device 10 receives the reply data, the anti-cheating record, and the verification data from the examination device. Then the host device 10 can restore the order of the replies in the reply data to the order corresponds to the first test data. After that, the reply data is compared with the answers in the database 12 for generating the examination score. The anti-cheating record may used to adjust the result of the examination score (S38).

Then the host device 10 sends the answers and the examination scores to the corresponding examination devices 20, in order to let the examinee know the examination score and the correct answers of this examination (S39). At the same time, the examination score may be sent to a predetermined E-mail address through the Internet by the first communication module 15. Alternatively, the examination score may be sent to a predetermined mobile phone number using a short message, so that others may know the examination score of the examinee (S40). And then the examination ends (S41).

Some modifications of these examples, as well as other possibilities will, on reading or having read this description, or having comprehended these examples, will occur to those skilled in the art. Such modifications and variations are comprehended within this invention as described here and claimed below. The description above illustrates only a relative few specific embodiments and examples of the invention. The invention, indeed, does include various modifications and variations made to the structures and operations described herein, which still fall within the scope of the invention as defined in the following claims.

What is claimed is:

1. An examination system, comprising:
a host device including:
a data base for storing a plurality of questions and a plurality of answers, in which the answers are respectively associated with the questions;
a randomizing module having a rearrangement function;
a first communication module for sending and receiving data;
a first verification module for verifying according to a set of verification data, and generating a verification signal according to the verification data; and
a first processing unit coupled with the data base, the randomizing module, the first communication module, and the first verification module, for generating a first test data which includes some of the questions from the data base according to the verification signal received from the first verification module, for controlling the randomizing module for rearranging the questions of the first test data so as to generate a second test data, and for controlling the communication module in order to send the second test data;
an examination device including:
an input unit for receiving an input signal;
a second communication module for sending and receiving data;
a display unit for displaying the second test data;
a second verification module for generating the verification data;
an anti-cheating module for generating an anti-cheating signal;
a storage unit for storing the input signal and the second test data; and
a second processing unit coupled with the second communication module, the display module, the second verification module, the anti-cheating module, the input unit, and the storage unit, for controlling the second communication module for sending the verification data and the input signal to the host device, for receiving the second test data and displaying the second test data at the display unit, and for generating an anti-cheating action according to the anti-cheating signal.

2. The examination system as in claim 1, wherein the randomizing module rearranges the questions of the first test data for generating the second test data according to at least one of an identity verification key, a machine code serial number and a program code serial number of the examination device, in which the questions in the second test data are the same as the questions of the first test data but in different order.

3. The examination system as in claim 1, wherein the anti-cheating module detects a distance between the examination device and the other examination device, and when the distance is less than a predetermined value, the anti-cheating module generates the anti-cheating signal, and the examination device then generates the anti-cheating action according to the anti-cheating signal.

4. The examination system as in claim 1, wherein the anti-cheating module has a image system for generating a character image, and when a deviation angle of the character image is greater than a predetermined value, the anti-cheating module generates the anti-cheating signal, and the examination device then generates the anti-cheating action according to the anti-cheating signal.

5. An examination method, comprising:
generating a first test data by a host device, in which the first test data has a plurality of questions;
rearranging the questions of the first test data for generating a second test data by a randomizing module; and
sending the second test data to a corresponding examination device by a first communication module.

6. The examination method as in claim 5, wherein the randomizing module rearranges the questions of the first test data for generating the second test data according to at least one of an identity verification key, a machine code serial number and a program code serial number of the examination device.

7. An examination method, comprising:
generating a test data by a host device, and sending the test data to an examination device for displaying;
generating an anti-cheating signal by an anti-cheating module; and
generating a reply data by the examination device, and sending the reply data to the host device for generating an examination score by the host device.

8. The examination method as in claim 7, wherein the anti-cheating module detects a distance between the examination device and the other examination device, and when the distance is less than a predetermined value, the anti-cheating module generates the anti-cheating signal.

9. The examination method as in claim 8, wherein the anti-cheating module is one of an infrared distance detection module and a radio signal distance detection module, and the examination device generates an anti-cheating action according to the anti-cheating signal.

10. The examination method as in claim 7, wherein the anti-cheating module detects a character image, and when a deviation angle of the character image is greater than a predetermined value, the anti-cheating signal is then generated.

11. The examination method as in claim 10, wherein the anti-cheating module is one of a complementary metal-oxide-semiconductor (CMOS) image module and a charge-coupled device (CCD) image module, and the examination device generates an anti-cheating action according to the anti-cheating signal.
